(19) United States
(12) Patent Application Publication
(10) Pub. No.: US 2013/0258093 A1
(43) Pub. Date: Oct. 3, 2013

(54) Inspection Tool and Image Pickup Device

(71) Applicant: HITACHI HIGH-TECHNOLOGIES CORPORATION, Tokyo (JP)

(72) Inventor: Takahiro JINGU, Takasaki (JP)

(73) Assignee: Hitachi High-Technologies Corporation, Tokyo (JP)

(21) Appl. No.: 13/767,420

(22) Filed: Feb. 14, 2013

(30) Foreign Application Priority Data
Mar. 30, 2012 (JP) 2012-079551

(51) Int. Cl. G01N 21/95

(52) U.S. Cl. CPC G01N 21/9501
USPC 348/92

(57) ABSTRACT

An inspection tool that can acquire large image data at a high speed while suppressing an increase in the size of a circuit, and an image pickup device that is used for the inspection tool, are provided. Image pickup devices that are used for the inspection tool each include: a plurality of photoelectronic devices of a photoelectron output type; a plurality of sample-and-hold circuits, each circuit being connected to corresponding one of the photoelectronic devices; an analog multiplexer connected to the plurality of sample-and-hold circuits; an analog-to-digital converting circuit connected to the analog multiplexer; and a package that stores the photoelectronic devices, the sample-and-hold circuits, the analog multiplexer and the analog-to-digital converting circuit.

### BACKGROUND OF THE INVENTION

1. Field of the Invention

The present invention relates to an optical inspection tool for inspecting a defect on a mirror surface wafer before formation of a circuit pattern or a defect on a wafer having a circuit pattern formed thereon, and an image pickup device used for the optical inspection tool.

2. Description of the Related Art

In a semiconductor manufacturing process, a scratch, a foreign particle, a stain and other defects (hereinafter collectively referred to as “defect”) on a mirror surface wafer (semiconductor substrate) before formation of a circuit pattern may cause insufficient insulation or short of a wiring formed later, insufficient insulation of a capacitor, or destruction of a gate oxide film. A defect of the circuit pattern formed on the wafer may affect an electrical characteristic of a semiconductor device. For the semiconductor manufacturing process, therefore, it is important to detect such a defect and feed back a result of the detection to the semiconductor manufacturing process.

One of inspection tools for detecting a defect of this type is an optical inspection tool. The optical inspection tool irradiates a wafer with light, and detects light scattered from the wafer, thereby detecting a defect on a surface of the wafer. As optical inspection tools, there are a surface inspection tool for inspecting a surface of a mirror surface wafer, and an patterned wafer inspection tool for inspecting a wafer with a circuit pattern formed thereon. For each of the inspection tools, an image pickup device that has a plurality of pixels can be used. Conventional examples of the inspection tool for detecting scattered light and the multi-pixel image pickup device are described in JP-2004-48549-A, JP-2011-137678-A, JP-9-23370-A, JP-2010-99095-A and the like.

### SUMMARY OF THE INVENTION

Photoelectronic devices such as a photodiode (PD) used for an image pickup device are of an optical current output type (consecutive output type) for directly outputting an optical current as a signal and of an optical current storage type (storage and output type) for storing an optical current in a junction capacitance of a PD and outputting the optical current after the storage. In general, a photoelectronic device of the optical current storage type is used for a multi-pixel image pickup device such as a charge coupled device (CCD) or a time delay integration (TDI). Thus, the image pickup device such as a CCD or a TDI temporarily stores an optical current in a junction capacitance and sequentially reads signals stored in pixels. Thus, outputting the signals takes a time period obtained by multiplying the number of the pixels by a period of time to read a signal from a single pixel, and an increase in the speed of an operation is limited.

If it is assumed that the diameters of wafers will be increased and a finer design rule for semiconductor integrated circuits will be provided, future needs for systems capable of acquiring inspection data with a larger amount at a higher speed are expected. As one of methods for satisfying the needs, photoelectronic devices of the optical current output type are used. There is no problem if the image pickup device has a single pixel. However, if a multi-pixel image pickup device is configured by photoelectronic devices of the optical current output type, circuits such as analog-to-digital converters (ADCs) are required for the pixels, in order to process signals sequentially output from the photoelectronic devices for the pixels. Thus, the size of a circuit for processing signals output from the image pickup device is increased.

The present invention was devised in view of the foregoing points, and an object of the invention is to provide an inspection tool capable of acquiring large image data at a high speed while suppressing the size of a circuit, and an image pickup device used for the inspection tool.

In order to accomplish the aforementioned object, there is provided an image pickup device including: a plurality of photoelectronic devices of a photoelectron output type; a plurality of sample-and-hold circuits, each circuit being connected to corresponding one of the photoelectronic devices; an analog multiplexer connected to the plurality of sample-and-hold circuits; an analog-to-digital converting circuit connected to the analog multiplexer; and a package that stores the photoelectronic devices, the sample-and-hold circuits, the analog multiplexers, and the analog-to-digital converting circuits.

According to the invention, it is possible to acquire large image data at a high speed while suppressing the size of a circuit.

### BRIEF DESCRIPTION OF THE DRAWINGS

FIG. 1 is a schematic diagram illustrating an inspection tool according to a first embodiment of the invention.

FIG. 2 is a top view illustrating an example of the configuration of an image pickup device according to the first embodiment of the invention.

FIG. 3 is a section view illustrating the example of the configuration of the image pickup device according to the first embodiment of the invention, taken along a line III-III of FIG. 2.

FIG. 4 is a section view illustrating another example of the configuration of the image pickup device according to the first embodiment of the invention and corresponding to FIG. 3.

FIG. 5 is a block diagram illustrating the image pickup device according to the first embodiment of the invention and circuits connected to the image pickup device.

FIG. 6 is a timing chart of operational timing of the image pickup device according to the first embodiment of the invention.

FIG. 7 is a timing chart of operational timing of a digital multiplexer included in an inspection tool according to the first embodiment of the invention.

FIG. 8 is a schematic diagram illustrating an inspection tool according to a second embodiment of the invention.

FIG. 9 is a block diagram illustrating an image pickup device according to the second embodiment of the invention and circuits connected to the image pickup device.

FIG. 10 is a timing chart of operational timing of the image pickup device according to the second embodiment of the invention.

FIG. 11 is a schematic diagram illustrating an inspection tool according to a third embodiment of the invention.

FIG. 12 is a block diagram illustrating an image pickup device according to the third embodiment of the invention and circuits connected to the image pickup device.

### DESCRIPTION OF THE PREFERRED EMBODIMENTS

Hereinafter, embodiments of the invention are described with reference to the accompanying drawings.

### First Embodiment

### 1. Configuration

### 1-1 Inspection Tool

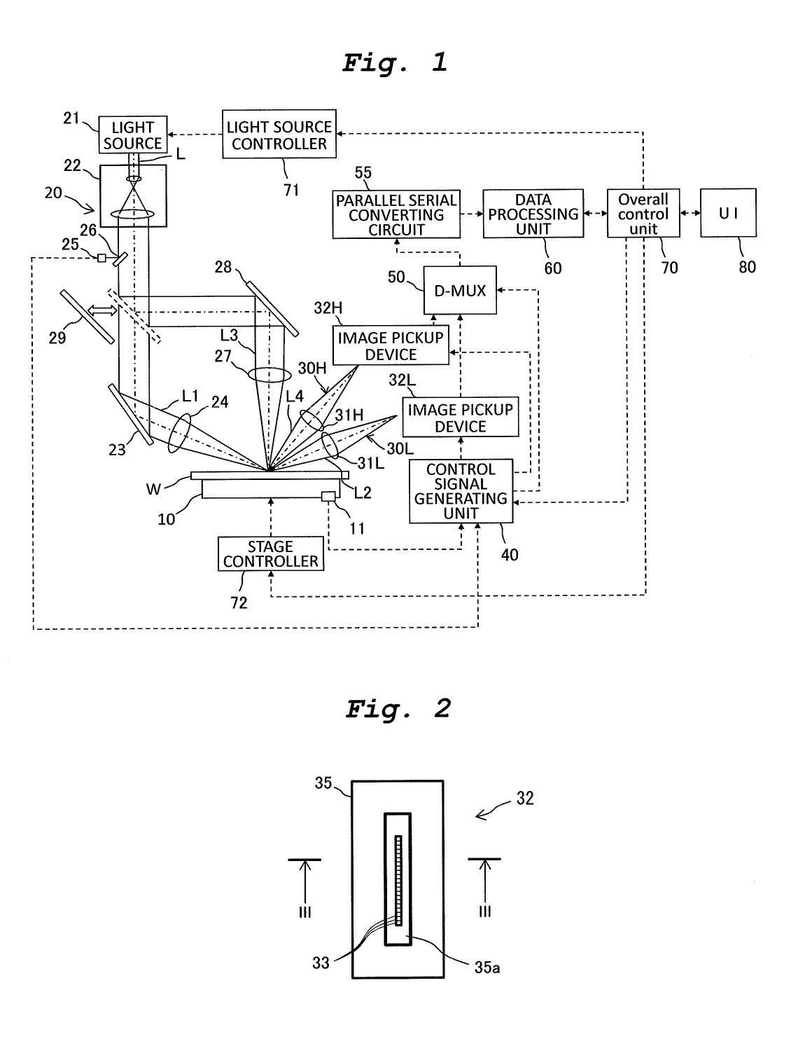

FIG. 1 is a schematic diagram illustrating an inspection tool according to the first embodiment of the invention.

The inspection tool illustrated in FIG. 1 includes a stage device 10, an illumination device 20, detection devices 30L and 30R, a control signal generating unit 40, a digital multiplexer (hereinafter referred to as “D-MUX”) 50, a parallel serial converting circuit 55, a data processing unit 60, an light source controller 71, a stage controller 72, an overall control unit 70 and a user interface (hereinafter referred to as “UI”) 80. The stage device 10 is adapted to hold a wafer W. The illumination device 20 switches between inspection light L1 (oblique illumination) and L3 (normal illumination) by placing and removing a reflecting mirror 29 above and from a surface of the wafer W placed on the stage device 10, and irradiates the surface of the wafer W with selected light. The detection devices 30L and 30H detect light L2 and L4 scattered from the wafer W and output the detected light as digital signals. At least one of an angle of elevation and azimuth angle of the light detected by the detection device 30L is different from those of the light detected by the detection device 30H. The control signal generating unit 40 controls operations of the detection devices 30L and 30H (specifically, image pickup devices 32L and 32H described later). The D-MUX 50 receives and outputs signals output from the detection devices 30L and 30H. The parallel serial converting circuit 55 executes parallel serial conversion on a signal received from the D-MUX 50. The data processing unit 60 processes a signal received from the parallel serial converting circuit 55. The light source controller 71 controls the illumination device 20. The stage controller 72 controls the stage device 10. The overall control unit 70 controls operations of the overall inspection tool that includes the control signal generating unit 40, the light source controller 71 and the illumination controller 72. The user interface 80 receives predetermined information such as settings for inspection of the wafer W and displays a result of the inspection.

### 1-2 Stage Device 10 and Stage Controller 72

The stage device 10 has a sample stage for horizontally holding the wafer W and a sample stage movement mechanism for moving the sample stage, although these components are not illustrated in detail. The sample stage movement mechanism has a θ table, an X table and an autofocus mechanism (not illustrated). The θ table rotates the sample stage about a vertical rotational axis in a θ direction in a horizontal plane. The X table moves the sample stage and the θ table in a horizontal direction (X direction). The autofocus mechanism moves the sample stage, the θ table and the X table in a vertical direction (Y direction) and automatically focuses the inspection light L1 and L3. The stage device 10 moves an XY table in X and Y directions appropriately while rotating the θ table in accordance with a control signal received from the stage controller 72 and moves the wafer W relative to the inspection light L1 and L3. Thus, the surface of the wafer W is scanned with the inspection light L1 and L3. The stage controller 72 outputs a control signal to the stage device 10 in accordance with a control value received from the overall control unit 70 on the basis of information input to and set in the user interface 80. In addition, a position detection encoder 11 for detecting a position on X and Y coordinates is arranged on the stage device 10. A detection signal that is detected by the position detection encoder 11 is output to the control signal generating unit 40.

### 1-3 Illumination Device 20 and Light Source Controller 71

The illumination device 20 includes a light source 21, an illumination shaping optical system 22, reflecting mirrors 23, 28 and 29 and illumination lenses 24 and 27. The light source 21 emits inspection light L. In the present embodiment, the light source 21 uses pulse illumination. The light source 21 emits the inspection light L with an intensity based on a control signal received from the light source controller 71. The illumination shaping optical system 22 uses a lens, an aperture or the like to shape the inspection light L1 output from the light source 21. The reflecting mirror 23 reflects the inspection light L received from the illumination shaping optical system 22 and causes an optical axis of the inspection light L to be inclined with respect to the surface of the wafer W (or irradiates the surface of the wafer W with the inspection light L from an oblique direction with respect to the surface of the wafer W). The illumination lens 24 focuses the inspection light L1 reflected by the reflecting mirror 23. The inspection light L1 converged by the illumination lens 24 is incident on the surface of the wafer W from an oblique direction. In addition, the reflecting mirror 29 changes an optical path of the inspection light L. The reflecting mirror 29 is moved by a driving device (not illustrated) and thereby placed on the optical path of the inspection light L output from the illumination shaping optical system 22 and removed from the optical path of the inspection light L. In this case, the reflecting mirror 29 is removed from the optical path of the inspection light L so as to cause the inspection light L to propagate to the reflecting mirror 23 and interferes with the optical path of the inspection light L so as to cause the inspection light L to propagate to the reflecting mirror 28. The reflecting mirror 28 reflects the inspection light L reflected by the reflecting mirror 29 and causes the optical axis of the inspection light L to be perpendicular to the surface of the wafer W (or irradiates the surface of the wafer W with the inspection light L in the vertical direction). The illumination lens 27 converges the inspection light L3 reflected by the reflecting mirror 28. The inspection light L3 converged by the illumination lens 27 is incident on the surface of the wafer W in the vertical direction. In addition, the illumination device 20 has a light detector 25 that detects the emitted inspection light L that is pulsed light. A part of the inspection light L reflected by a transmittance mirror 26 is incident on the light detector 25. A detection signal that is detected by the light detector 25 is output to the control signal generating unit 40. A photodiode or the like may be used as the light detector 25. It is sufficient if the photodiode used as the light detector 25 has a single pixel.

### 1-4 Detection Devices 30L, 30H, D-MUX 50 and Control Signal Generating Unit 40

The detection devices 30L and 30H have detection lenses 31L and 31H and image pickup devices 32L and 32H, respectively. The detection lenses 31L and 31H gather scattered light L2 and L4 generated by diffused reflection of the inspection light L1 and L3 on the surface of the wafer W. The image pickup devices 32L and 32H detect the light L2 and L4 scattered from the wafer W and gathered by the detection lenses 31L and 31H.

FIG. 2 is a plan view (diagram viewed from the side of incidence of the scattered light) of an example of the configuration of the image pickup device 32L. FIG. 3 is a section view taken along a line illustrated in FIG. 2. The members described above and illustrated in FIGS. 2 and 3 are indicated by the same reference numerals and symbols as those illustrated in FIG. 1, and a description thereof is omitted. The configuration of the image pickup device 32H is not illustrated in FIGS. 2 and 3, but is the same as the configuration of the image pickup device 32L.

The image pickup device 32L is a system-in-package (SiP) and has photoelectronic devices 33, signal processing function chips 34A, a package 35 and an input/output pin 36. The photoelectronic devices 33 are of a photoelectron output type that do not store an optical current in junction capacitances and sequentially output optical currents generated by photoelectric conversion. The present embodiment exemplifies the photoelectronic devices 33 that are arranged in a row and formed in a line sensor shape. The signal processing function chips 34A surround the photoelectronic devices 33 and each have a function (described later) of selecting a signal output from the plurality of photoelectronic devices 33 in accordance with a certain rule, digitalizing the selected signal and outputting the digital signal. The package 35 stores and modularizes the photoelectronic devices 33 and the signal processing function chips 34A. A material of the package 35 is, for example, ceramic or resin and may be changed depending on a usage environment of the inspection tool and a specification regarding an increase in the temperature of the image pickup device 32L. The package 35 includes an optical window 35a that causes the scattered light L2 to pass therethrough. The scattered light L2 generated on the surface of the wafer W passes through the optical window 35a and is incident on any of the photoelectronic devices 33. A material of the optical window 35a and specifications of an antireflective film of the optical window 35a may be changed depending on the wavelength of the scattered light L2. The input/output pin 36 is a terminal that receives and outputs signals from and to the control signal generating unit 40 and the D-MUX 50.

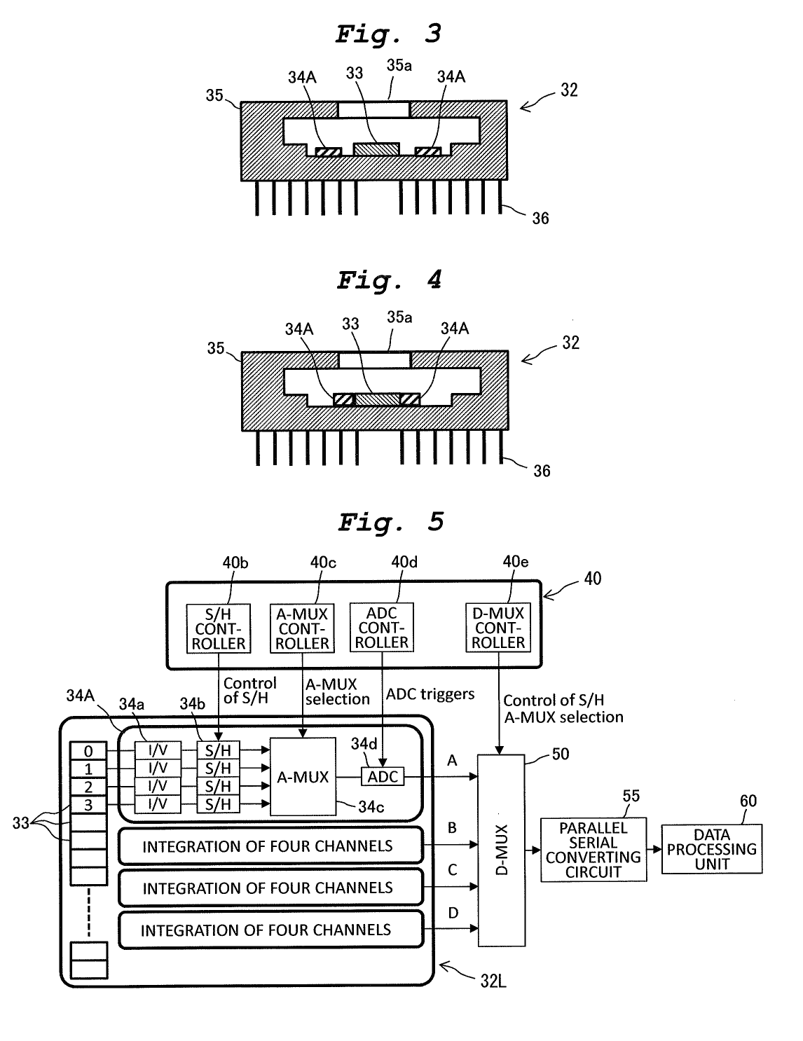

FIG. 3 exemplifies that the photoelectronic devices 33 and the signal processing function chips 34A are formed as different chips and included in the package 35. As another configuration example illustrated in FIG. 4, the photoelectronic devices 33 and the signal processing function chips 34A may be formed on the same chip and included in the package 35.

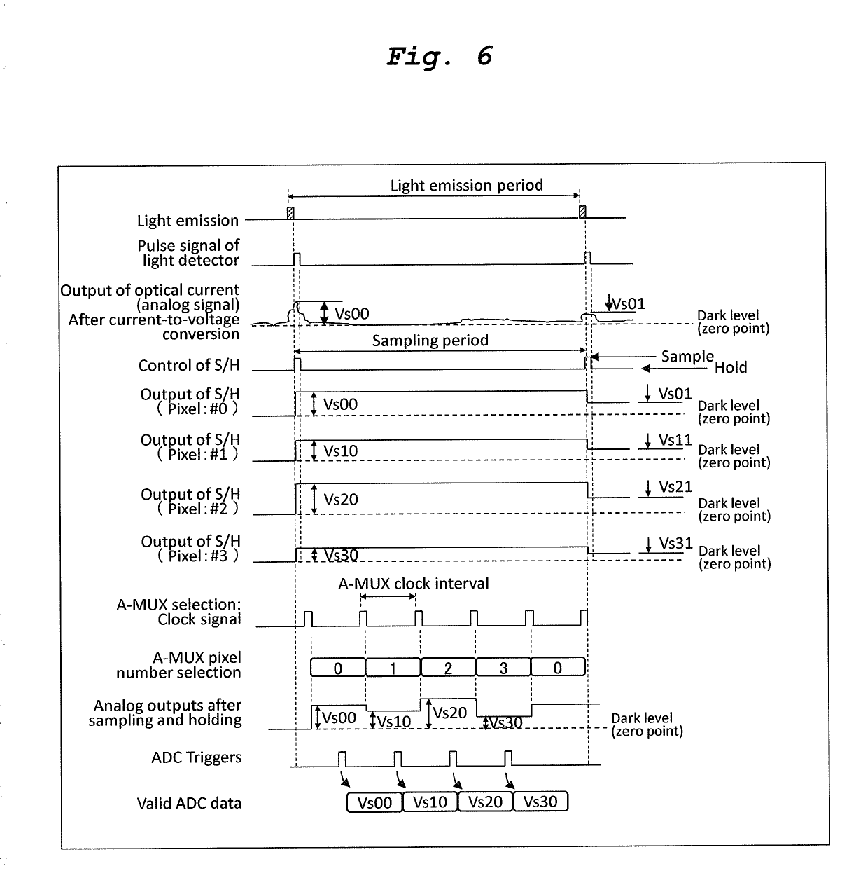

FIG. 5 is a block diagram illustrating the image pickup device 32L and circuits connected to the image pickup device 32L. The members described above and illustrated in FIG. 5 are indicated by the same reference numerals and symbols as those illustrated in FIGS. 1 to 4, and a description thereof is omitted. The configuration of the image pickup device 32H is not illustrated in FIG. 5, but is the same as the configuration of the image pickup device 32L.

As illustrated in FIG. 5, the signal processing function chips 34A each have a plurality of sample-and-hold circuits (hereinafter referred to as “S/Hs”) 34b, an analog multiplexer (hereinafter referred to as “A-MUX”) 34c and an analog-to-digital converter (hereinafter referred to as “ADC”) 34d. The present embodiment exemplifies that the plurality of S/Hs 34b (four in the example of FIG. 5), the single A-MUX 34c and the single ADC 34d are mounted on each of the single signal processing function chips 34A. The A-MUX 34c is connected to the plurality of S/Hs 34b and the ADC 34d. The image pickup device 32L has the plurality of signal processing function chips 34A (four in the example of FIG. 5) configured as described above. The ADCs 34d of the signal processing chips 34A are connected to the single D-MUX 50.

The control signal generating unit 40 has a sample-and-hold controller (hereinafter referred to as “S/H controller”) 40b, an analog multiplexer controller (hereinafter referred to as “A-MUX controller”) 40c, an analog-to-digital converting circuit controller (hereinafter referred to as “ADC controller”) 40d and a digital multiplexer controller (hereinafter referred to as “D-MUX controller”) 40e.

The S/H controller 40b outputs a control signal for switching between sampling and holding operations of the S/Hs 34b in accordance with a command value received from the overall control unit 70. The S/Hs 34b acquire signals output from the photoelectronic devices 33 in accordance with an instruction provided for a sampling operation by the S/H controller 40b and hold the acquired signals during an instruction for a holding operation. A plurality of current-to-voltage converters (hereinafter referred to as “I/Vs”) 34a are mounted on each of the signal processing function chips 34A according to the present embodiment. The S/Hs 34b are connected to the photoelectronic devices 33 through the I/Vs 34a, respectively. Optical currents output from the photoelectronic devices 33 are converted into voltages by the I/Vs 34a, and the converted voltages are input to the S/Hs 34b. Hereinafter, a cycle from the start of execution of one sampling operation through execution of one holding operation to the start of execution of the next sampling operation is described as a “sampling period”.

The A-MUX controller 40c outputs a control signal for switching between operations of inputting and outputting a signal to and from the A-MUXs 34c of the signal processing function chips 34A in accordance with a command value received from the overall control unit 70. Each of the A-MUXs 34c repeatedly switches the S/Hs 34b (from which signals are received by the A-MUXs 34c) in order from 0, 1, 2, 3, 0, . . . , in accordance with clocks received from the A-MUX controller 40c and outputs the signals received in the order to the corresponding ADC 34c. The numbers “0”, “1”, “2” and “3” are numbers of the photoelectronic devices 33 illustrated in FIG. 5 and are used for the corresponding I/Vs 34a and S/Hs 34b. An operational clock of each of the A-MUXs 34c has a frequency that enables signals output from all the photoelectronic devices 33 connected to the single A-MUX 34c to be acquired once or more during one sampling period of each of the S/Hs 34b. For example, if the number of the photoelectronic devices 33 connected to each of the signal processing function chip 34A is N (4 in the present embodiment), a signal input source needs to be switched the number N of times or more during a single sampling period and a clock frequency of the A-MUX 34c needs to be N times as high as a sampling frequency of the S/Hs 34b or higher.

The ADC controller 40d outputs a trigger signal to the ADCs 34d at the same intervals as operational clocks of the A-MUXs 34c in accordance with a command value received from the overall control unit 70. As a result, signals output from the A-MUXs 34c are sequentially digitalized by the ADCs 34d and output to the D-MUX 50. The signals input to the D-MUX 50 are values that indicate the intensities of the scattered light detected by the photoelectronic devices 33. Thus, the signals output from the image pickup device 32L according to the present embodiment are digital signals.

The D-MUX controller 40e outputs, to the D-MUX 50 in accordance with a command value received from the overall control unit 70, both control signal for switching between the operations of sampling and holding signals and control signal for switching signals to be output. The D-MUX 50 concurrently acquires signals A, B, C and D output from the signal processing function chips 34A in accordance with a sampling instruction received from the D-MUX controller 40e and holds the acquired signals only for a sampling period. A sampling frequency of the D-MUX 50 can be matched with operational frequencies of the A-MUXs 34c, for example. The D-MUX 50 sequentially outputs, to the parallel serial converting circuit 55, the signals A, B, C and D within the sampling period in accordance with a clock received from the D-MUX controller 40e. The signals A, B, C and D output from the signal processing function chips 34A include the signals of all the photoelectronic devices 33 (indicated by the numbers 0 to 3) for the signal processing function chips 34A. A data rate of the D-MUX 50 is equal to or higher than a value obtained by multiplying a data rate of the A-MUXs 34c by the number (4 in the present embodiment) of the signal processing function chips 34A connected to the D-MUX 50. The signals output from the D-MUX 50 are associated with a signal output from the position detection encoder 11 of the stage device 10, and whereby positions at which the signals output from the D-MUX 50 are generated on the wafer W can be discriminated.

### 1-5 Data Processing Unit 60

The data processing unit 60 acquires information of the position, size and the like of a defect from data received from the parallel serial converting circuit 55. The data processing unit 60 discriminates a signal with a higher intensity than a threshold (set value) as a defect signal and discriminates the information of the position, size and the like of the defect on the basis of the signal intensity and positional data that is associated with the signal and indicates the position of the stage device 10. Since the multi-pixel image pickup device 32L is used in the present embodiment, detailed information on the size of the defect can be acquired by determining the number of pixels (adjacent pixels) that simultaneously detect the scattered light L2, for example.

### 1-6 Overall Control Unit 70

The overall control unit 70 (refer to FIG. 1) has a function of outputting control values to the control signal generating unit 40, the light source controller 71, the stage controller 72 and the like in accordance with conditions set in the UI 80, as described above. The overall control unit 70 has a storage unit (not illustrated) that stores inspection data received from the data processing unit 60 or the control values output to the control signal generating unit 40, the light source controller 71, the stage controller 72 and the like.

### 1-7 UI 80

The UI 80 displays a setting screen for inspection modes such as a “high resolution mode”, a “standard mode” and a “high throughput mode”. Conditions for inspection are set in the UI 80 by selecting a mode from among the inspection modes. When a mode is selected, the overall control unit 70 calculates operational control values based on the selected mode and outputs the calculated control values to the control signal generating unit 40 and the like. The conditions for the inspection, which are an operation of acquiring a signal on the basis of the number of times when the light source 21 emits light, a distance by which the stage device 10 moves, or the like, can be set by entering values for items without selection of a mode.

### 1-8 Photoelectronic Devices 33

Representative examples of optical current output type photoelectronic devices used as the photoelectronic devices 33 are photodiodes (hereinafter referred to as PDs), avalanche photodiodes (hereinafter referred to as APDs) and multi-pixel photon counters (hereinafter referred to as MPPCs). Operational principles of the PDs, APDs and MPPCs are described below.

The PDs are light receiving elements that each generate a current or a voltage when a PN junction of a semiconductor is irradiated with light. When light with higher energy than band gap energy is incident on a PD, an electron in a valence band are excited to a conduction band. As a result, a hole remains in the valence band. Pairs of electrons and holes are generated in a P layer, an N layer and a depletion layer on the basis of the amount of the incident light. The depletion layer is a neutron region of the junction of the P layer and the N layer. In the depletion layer, electrons are accelerated toward the N layer by an electric field, and holes are accelerated toward the P layer by the electric field. Electrons within the N layer, together with electrons that have flowed from the P layer, remain in a conductive body of the N layer, while holes within the N layer diffuse to the depletion layer and are accelerated and collected in a P layer valence band. Thus, the P layer is positively charged, while the N layer is negatively charged. Electrons flow from the N layer and holes flows from the P layer, and whereby an optical current is generated. If the PDs are used as the photoelectronic devices 33, optical currents that are sequentially generated by incidence of the scattered light L2 according to the aforementioned principle are input to the I/Vs 34a.

The APDs are one type of PDs and are high-speed, highly sensitive PDs that output optical currents multiplied by applying reverse voltages. Each of the APDs is a device that counts the number of photons forming light and measures the amount of the light. If a reverse voltage of an APD is set to a value that is equal to or higher than a breakdown voltage, an internal electric field increases and a multiplication rate significantly increases (10⁵ to 10⁶ times). A mode in which the APDs are operated at the high multiplication rate is referred to as a Geiger mode. A pair of an electron and a positive hole that are generated at the PN junction by incidence of photons in the Geiger mode is accelerated by a high electric field. In this case, the electron generated by the incidence of the photons is accelerated in the P layer so as to have increased kinetic energy, propagates toward the N layer, obtains sufficiently higher kinetic energy than band gap energy of the N layer, propagates into the N layer and pushes an electron out of the N layer. Then, the electron pushed out of the N layer causes a larger number of electrons to be generated by a chain reaction. This is a principle of a multiplication effect. When a single photon is incident on an APD in the Geiger mode, a significantly large pulse signal is generated by the multiplication effect. Thus, the number of photons can be counted on the basis of pulse signals. Light is a group of photons, and the photons are discrete when the light is extremely weak. The APDs, however, can measure even extremely weak light using the aforementioned multiplication effect with high sensitivity. The APDs each output a current with an amount based on the number of photons detected per unit time. The sensitivity of the APDs to extremely weak light is higher than those of the PDs.

The MPPCs are one type of devices referred to as silicon photomultipliers (Si-PMs) and are each a collection of APDs in the Geiger mode that separately operate. The APDs that form pixels of the MPPCs output pulse signals when detecting photons in the aforementioned manner. The output of each of the MPPCs indicates the total sum of all pixels, and the number of photons is counted on the basis of the output. If the MPPCs are used as the photoelectronic devices 33, each of which is a single pixel of the image pickup device 32L or 32H, the photoelectronic devices 33 can detect extremely weak light with high sensitivity.

### 2. Operations

FIG. 6 is a timing chart of operational timing of the image pickup device 32L. Operations of the image pickup device 32H are the same as operations of the image pickup device 32L.

Since the light source 21 uses pulse illumination in the present embodiment, a pulse signal is input from the light detector 25 to the control signal generating unit 40 at intervals at which the light source 21 emits light (refer to the top two lines of FIG. 6). The photoelectronic devices 33 output optical currents at intervals equivalent to the pulse signal of the light detector 25 (refer to the third line from the top line of FIG. 6). Strictly speaking, in FIG. 6, the outputs of the photoelectronic devices 33 are not the optical currents and are optical voltage values obtained by converting the optical currents by the I/Vs 34a. An optical voltage value of light emitted first is Vs00, while an optical voltage value of light emitted second is Vs01 (<Vs00). If a threshold that is used to discriminate a defect signal is between the values Vs00 and Vs01, the downstream-side data processing unit 60 discriminates, as a defect signal, the optical voltage Vs00 detected from the light emitted first and discriminates or filters, as a non-defect signal, the optical voltage Vs01 detected from the light emitted second. FIG. 6 illustrates an output of a single photoelectronic device 33 (photoelectronic device 33 indicated by the number 0 and illustrated in FIG. 5 in this case) as a representative example. In fact, however, the other photoelectronic devices 33 output optical currents at the same intervals. Although different photoelectronic devices 33 may output optical currents with the same value due to the same light emission, values of optical currents output from the photoelectronic devices 33 are basically different from each other.

The case where the UI 80 is set to acquire outputs of all the pixels at the intervals at which the light source 21 emits light is exemplified. In this case, the sampling periods of the S/Hs 34b are equal to the intervals at which the light source 21 emits light. The case assumes that the start time of the sampling period is the time when the light detector 25 generates a pulse signal, and the end time of the sampling period is the time when the light detector 25 generates the next pulse signal. Specifically, when the control signal generating unit 40 receives the pulse signal from the light detector 25, a pulse signal that instructs the S/Hs 34b to execute sampling is output from the S/H controller 40b to the S/Hs 34b (refer to the fourth line from the top line of FIG. 6). Thus, signals output from the photoelectronic devices 33 indicated by the numbers 0 to 3 upon emission of light are held by the corresponding S/Hs 34b until the next sampling (refer to the fifth to eighth lines from the top line of FIG. 6). This case assumes that values of the signals held by the S/Hs 34b corresponding to the numbers 0 to 3 are Vs00 to Vs30, respectively.

The A-MUX controller 40c outputs, to the A-MUXs 34c, a clock signal with a frequency that is equal to or higher than four times as high as the sampling frequency of the S/Hs 34b (or equal to or higher than several times as high as the photoelectronic devices 33 connected to the signal processing function chips 34A) (refer to the fifth line from the lowermost line of FIG. 6). Every time each of the A-MUXs 34c receives a clock signal from the A-MUX controller 40c, the A-MUX 34c selects an S/H 34b as a signal source in order of the numbers 0, 1, 2, 3, 0, . . . (refer to the fourth line from the lowermost line of FIG. 6). Thus, the values Vs00 to Vs30 of the signals held by the S/Hs 34b for the sampling period due to the outputs of the photoelectronic devices 33 indicated by the numbers 0 to 3 are input to the A-MUX 34c during the sampling period and sequentially output from the A-MUX 34c (refer to the third line from the lowermost line of FIG. 6). In this case, the ADC controller 40d outputs, to the ADC 34d, a trigger signal with a frequency that is equal to or nearly equal to a clock frequency of the A-MUX 34c (refer to the second line from the lowermost line of FIG. 6). Thus, analog signals output from the A-MUX 34c are sequentially digitalized by the ADC 34d and output to the D-MUX 50 (refer to the lowermost line of FIG. 6).

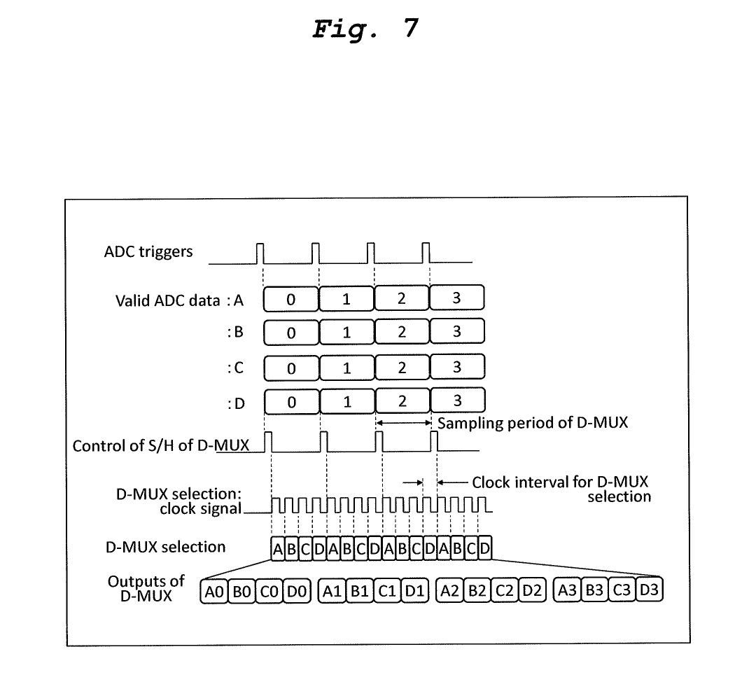

FIG. 7 is a timing chart of operational timing of the D-MUX 50.

As illustrated in FIG. 7, the D-MUX 50 receives the signals A, B, C and D (refer to FIG. 5) digitalized by the ADCs 34d in the plurality of signal processing function chips 34A (four signal processing function chips 34A in the present embodiment) connected to the D-MUX 50. Outputs (A0 to D0) of the photoelectronic devices 33 indicated by the number 0 are input from the ADCs 34d to the D-MUX 50 on the basis of the first ADC trigger illustrated in FIG. 7. In the same manner, outputs (A1 to D1) of the photoelectronic devices 33 indicated by the number 1 are input from the ADCs 34d to the D-MUX 50 on the basis of the second ADC trigger. Outputs (A2 to D2) of the photoelectronic devices 33 indicated by the number 2 are input from the ADCs 34d to the D-MUX 50 on the basis of the third ADC trigger. Outputs (A3 to D3) of the photoelectronic devices 33 indicated by the number 3 are input from the ADCs 34d to the D-MUX 50 on the basis of the fourth ADC trigger (refer to top five lines of FIG. 7).

In this case, the D-MUX controller 40e outputs, to the D-MUX 50, a pulse signal that instructs the D-MUX 50 to execute sampling at intervals that are equal to intervals between the ADC triggers (refer to the fourth line from the lowermost line of FIG. 7). Thus, the signals A to D received from the ADCs 34d are held by the D-MUX 50 for a sampling period of the D-MUX 50. The D-MUX controller 40e outputs, to the A-MUXs 34c, a clock signal with a frequency that is equal to or higher than four times as high as the sampling frequency of the D-MUX 50 (or equal to or higher than several times as high as the ADCs 34d connected to the D-MUX 50) (refer to the third line from the lowermost line of FIG. 7). Every time the D-MUX 50 receives a clock signal from the D-MUX controller 40e, the D-MUX 50 switches a signal to be output to the parallel serial converting circuit 55 in order of the signals A, B, C, D, . . . (refer to the second line from the lowermost line of FIG. 7). Thus, all the outputs A0 to D0 of the photoelectronic devices 33 (included in the signal processing function chips 34A) indicated by the number 0 are output to the parallel serial converting circuit 55 during the sampling period of the D-MUX 50. By repeatedly executing this operation, the outputs A1 to D1 of the photoelectronic devices 33 (included in the signal processing function chips 34A) indicated by the number 1, the outputs A2 to D2 of the photoelectronic devices 33 (included in the signal processing function chips 34A) indicated by the number 2, and the outputs A3 to D3 of the photoelectronic devices 33 (included in the signal processing function chips 34A) indicated by the number 3 are sequentially output to the parallel serial converting circuit 55.

As a result of the aforementioned operations, the outputs of all the pixels of the image pickup device 32L are acquired during one sampling period of the S/Hs 34b. The same applies to the image pickup device 32H.

### 3. Effects

### 3-1 Achievement of Both Increase in Processing Speed of Image Pickup Devices and Suppression of Size of Processing Circuit

Since the photoelectronic devices 33 of the photoelectron output type are used in the image pickup devices 32L and 32H, the image pickup devices 32L and 32H can output the signals at a higher speed than a conventional multi-pixel image sensor (such as a CCD) that accumulates an optical current in a junction capacitance and outputs the optical current. For example, while a cutoff frequency of a CCD is approximately 50 MHz, the PDs, APDs, MPPCs and the like that may be used as the photoelectronic devices 33 have frequency bands in a range of 300 MHz to 500 MHz and thereby exhibit the effect of increasing the processing speed.

In this case, the S/Hs 34b and the A-MUXs 34c are mounted in the image pickup devices 32L and 32H, and the number of the channels for outputs of the plurality of pixels is reduced at a stage at which analog signals are processed. Thus, the number of the ADCs 34d can be significantly smaller than the number of the photoelectronic devices 33. Signals can be simultaneously output from the plurality of pixels and sequentially transferred to the common ADCs 34d through the S/Hs 34b and the A-MUXs 34c. Thus, even if the number of the ADCs 34d is small, accurate data of all the pixels of the image pickup devices 32L and 32H can be obtained only if the outputs of the ADCs 34d are consistent. Since the number of the output channels of the image pickup devices 32L and 32H is suppressed and the signals output from the image pickup devices 32L and 32H are already digitalized, it is possible to suppress an increase in the size of the circuit for processing the signals of the image pickup devices 32L and 32H.

As described above, according to the present embodiment, it is possible to acquire large image data at a high speed by outputting signals from the sensors at a high speed while suppressing an increase in the size of the circuit for processing signals to be output from the image pickup devices 32L and 32L. Thus, even if there will be a need to acquire large inspection data at a high speed in the future due to increases in the sizes of wafers and miniaturization of semiconductor integrated circuits, the image pickup devices 32L and 32H can be flexibly supported.

Since sensor outputs are conventionally analog signals, it is necessary to connect the conventional sensor to ADCs for output channels. In the present embodiment, however, the image pickup devices 32L and 32H output digital signals, and it is not necessary to connect the image pickup devices 32L and 32H to ADCs. This contributes to a reduction in the size of the circuit.

### 3-2 Consolidation of Functions in Image Pickup Devices

Circuit configurations of the photoelectronic devices 33, I/Vs 34a, S/Hs 34b and A-MUXs 34c are simple and can be formed on the sensor chips. In addition, as described above, since the S/Hs 34b and the A-MUXs 34c suppress the number of the ADCs 34d in a skilled way, the ADCs 34d can be mounted on the same chips. Thus, the functions of the photoelectric conversion and the current-to-voltage conversion, the function of switching between the signal transmission paths and the function of outputting digital signals can be consolidated in each of the image pickup devices 32L and 32H.

### 3-3 Detection of Amount of Extremely Weak Light

Further miniaturization of semiconductor integrated circuits is expected in the future. As a result, it is considered that light scattered from a defect upon inspection is weaker and a conventional inspection tool may not detect the defect completely. For commercial products, photoelectronic devices or the like of so-called back illuminated sensors and the like have been improved. For severe industrial fields, however, the back illuminated sensors and the like do not necessarily support the requests satisfied by the inspection tool according to the present embodiment.

On the other hand, in the present embodiment, the image pickup devices that use the optical current output type photoelectronic devices 33 can be achieved by the aforementioned configuration. If the APDs or the MPPCs are applied to the photoelectronic devices 33, it can be expected that SN ratios are significantly improved compared with image pickup devices used in a conventional inspection tool of the same type because the APDs and the MPPCs each have an electron multiplying function. In addition, a dynamic range can be increased. Thus, although the aforementioned configuration is compact, precise inspection data with high contrast can be acquired and it is possible to satisfy future needs to support a reduction, caused by miniaturization of an object to be inspected, in the intensity of scattered light and accurately image extremely weak light at a high speed.

In addition, the accuracy of detecting the amount of extremely weak light is improved. Thus, even if the intensity of a signal is reduced by increasing the sampling frequency, scattered light can be detected with high accuracy. That is, higher-resolution inspection data can be acquired.

### 3-4 Suppression of Noise

In the present embodiment, since the light source 21 uses the pulse illumination, the photoelectronic devices 33 output signals only when the light source 21 emits light. Thus, noise (mainly thermal noise) generated by the sensors themselves and noise of the signal processing circuit can be suppressed. The noise suppression contributes to the improvement of the SN ratios, improvement of inspection of a low-reflectivity object (to be inspected) and improvement of the accuracy of detecting a defect.

Traditionally, photoelectronic devices have been distributed on a photoelectronic device basis separately from circuits for digitalizing signals of the photoelectronic devices and therefore normally connected to a processing circuit such as an ADC through terminals and cables in order to assemble a device. Thus, it is unavoidable to transfer extremely weak optical currents to the processing circuit through the long terminal and cables, and whereby the optical currents are easily affected by noise and disturbance. Thus, a reduction in the size of the device that includes the processing circuit is limited.

On the other hand, in the present embodiment, the packaging of the photoelectronic devices 33, the I/Vs 34a, the S/Hs 34b, the A-MUXs 34c and the ADCs 34d contributes to both suppression of an effect of noise and downsizing of the inspection tool.

### 3-5 Ease of Handling

Since the optical current output type photoelectronic devices 33 are used, a circuit for reading a signal is not required. Thus, the flexibility of the shapes and layout of the pixels is high, and the image pickup devices 32L and 32H can be flexibly designed for each of inspection tools. In addition, since the photoelectronic devices 33 are packaged with the signal processing function chips 34A, the optical current output type photoelectronic devices 33 can be used in the same manner as optical current storage type photoelectronic devices. Furthermore, the image pickup devices 32L and 32H can be relatively easily mounted in an existing inspection tool.

### 3-6 Suppression of Cost

A circuit for driving the image pickup devices 32L and 32H is simple (bias setting). In addition, the image pickup devices 32L and 32H can be configured by low-cost parts, and the number of processes of manufacturing the image pickup devices 32L and 32H is small. Thus, the image pickup devices 32L and 32H can be manufactured at low cost.

### 3-7 High Resolution

Since the circuit can be downsized as described above, a large number of photoelectronic devices 33 can be arranged and high resolutions of the image pickup devices 32L and 32H can be easily achieved (for example, each of the image pickup devices 32L and 32H has 8000 pixels). The high resolutions of the image pickup devices 32L and 32H contribute to improvement of the inspection accuracy. In addition, if the image pickup devices 32L and 32H are applied to an inspection tool that scans a wafer surface in X and Y directions, an increase in the number of photoelectronic devices 33 results in an increase in a scanning range, a reduction in the number of times of returning and a reduction in a period of time for an inspection.

### Second Embodiment

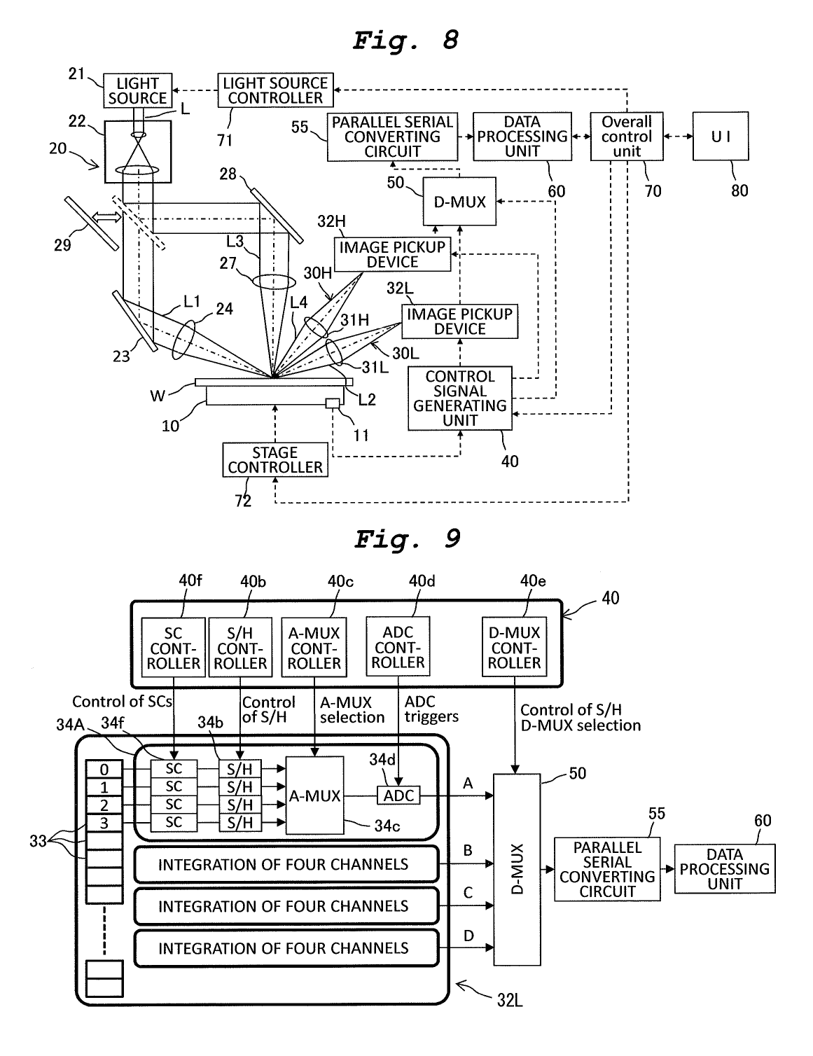

FIG. 8 is a schematic diagram illustrating an inspection tool according to the second embodiment of the present invention. FIG. 9 is a block diagram illustrating the image pickup device 32L and the circuits connected to the image pickup device 32L. FIGS. 8 and 9 correspond to FIGS. 1 and 5. The members described above and illustrated in FIGS. 8 and 9 are indicated by the same reference numerals and symbols as those illustrated in FIGS. 1 to 5, and a description thereof is omitted. The configuration of the image pickup device 32H is not illustrated in FIG. 9, but is the same as the configuration of the image pickup device 32L.

The second embodiment is different in the following points from the first embodiment. While the outputs of the pixels are acquired on the basis of the pulsed light emitted by the light source 21 in the first embodiment, the outputs of the pixels are acquired on the basis of the amount of a movement of the stage device 10 in the second embodiment. Regarding hardware, the second embodiment is different in the following four points from the first embodiment. The first point is that the light source 21 does not emit pulsed light and continuously emits light. The second point is that the light detector 25 (refer to FIG. 1) and the transmittance mirror 26 (refer to FIG. 1) for guiding the inspection light to the light detector 25 are omitted. The third point is that the I/Vs 34a (refer to FIG. 5) of the signal processing function chips 34A of the image pickup device 32L are replaced with storage capacitors (hereinafter referred to as SCs) 34f. The fourth point is that a storage capacitor controller (hereinafter referred to as “SC controller”) 40f is added to the control signal generating unit 40. The SC controller 40f outputs, to the SCs 34f, a control signal for switching between an operation of accumulating an optical current and an operation of discharging an optical current. The SCs 34f accumulate and discharge optical currents generated by the photoelectronic devices 33 in accordance with an instruction received from the SC controller 40f. Other configurations are the same as those described in the first embodiment.

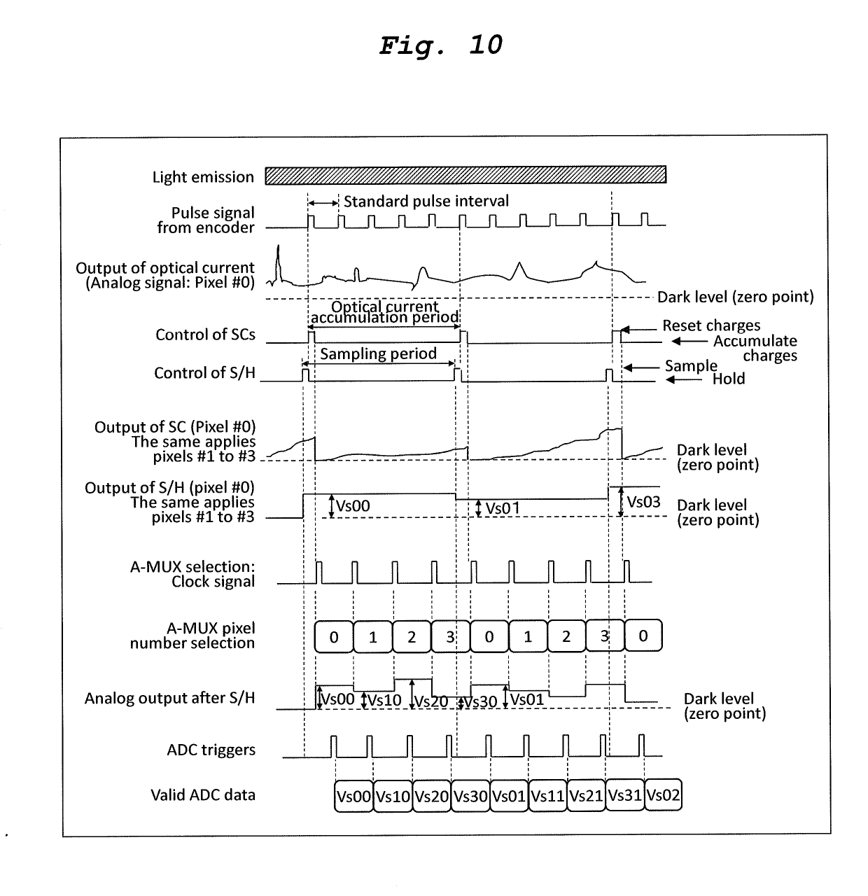

FIG. 10 is a timing chart of operational timing of the image pickup device 32L according to the present embodiment and corresponds to FIG. 6. A description of items that are included in FIG. 10 and overlap the items described with reference to FIG. 6 is omitted. Operations of the image pickup device 32H are the same as operations of the image pickup devices 32L.

FIG. 10 exemplifies a case where the image pickup devices 32L and 32H are set so that when the stage device 10 is moved a certain distance (for example, a distance corresponding to five pulse signals of the position detection encoder 11) by the UI 80, outputs of all the pixels during the movement are acquired. Since the light source 21 uses continuous illumination in the present embodiment (refer to the top line of FIG. 10), optical currents are continuously output from the photoelectronic devices 33 (refer to the third line from the top line of FIG. 10). The optical currents vary. FIG. 10 illustrates an output of a single photoelectronic device 33 (photoelectronic device 33 indicated by the number 0 illustrated in FIG. 9 in this case) as a representative example. In fact, however, the other photoelectronic devices 33 output optical currents. A pulse signal is input to the control signal generating unit 40 from the position detection encoder 11 of the stage device 10 on the basis of a movement of the stage device 10 in X and Y directions (refer to the second line from the top line of FIG. 10).

This example assumes that a period of time from the start time when a certain first pulse signal is input to the control signal generating unit 40 from the position detection encoder 11 to the end time when a sixth pulse signal from the certain first pulse signal is input to the control signal generating unit 40 is referred to as an “optical current accumulation period” (refer to the fourth line from the top line of FIG. 10). Specifically, when the pulse signal is input from the position detection encoder 11 at the start time, and a pulse signal that instructs the SCs 34f to accumulate optical currents is output from the SC controller 40, the SCs 34f start to accumulate the optical currents. Next, when the pulse signal is input at the end time, the SCs 34f discharge (output) the accumulated optical currents and start to accumulate optical currents again (refer to the sixth line from the top line of FIG. 10).

As indicated by the fifth line of FIG. 10, the time length of the sampling period of the S/Hs 34b is equal to the time length of the optical current accumulation period of the SCs 34f. The start time of the sampling period of the S/Hs 34b, however, is immediately before the start time of the optical current accumulation period of the SCs 34f. Immediately before the discharging of the SCs 34f, a pulse signal that instructs the S/Hs 34f to sample data is output from the S/H controller 40b to the S/Hs 34b. The end time of the sampling period of the S/Hs 34b is immediately before the start time of the next optical current accumulation period. Immediately before the next discharging of the SCs 34f, a pulse signal that instructs the S/Hs 34b to sample data is output from the S/H controller 40b to the S/Hs 34b again. Specifically, in order to sample the amount of optical currents accumulated for the optical current accumulation period, the amount of optical currents accumulated at the end time of the optical current accumulation period corresponding to the previous sampling period is acquired and held for the constant sampling period (refer to the seventh line from the top line of FIG. 10).

Operations of the A-MUXs 34c, ADCs 34d and D-MUX 50 are the same as those described in the first embodiment.

In the present embodiment, by using the pulse signal that is output at short intervals for an inspection operation as a trigger without use of the pulse illumination, the operations that are the same as or similar to the operations of the imager pickup devices 32L and 32H according to the first embodiment can be executed. Effects that are the same as or similar to the effects obtained in the first embodiment can be obtained in the second embodiment.

### Third Embodiment

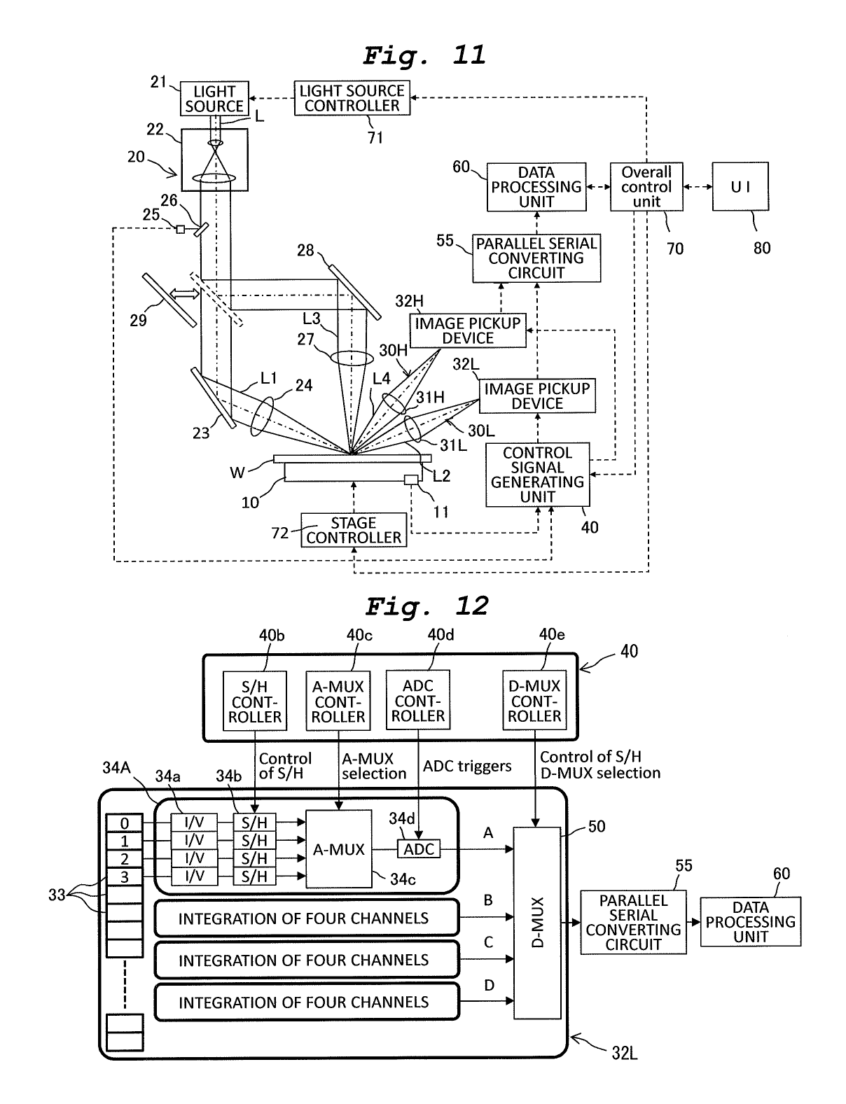

FIG. 11 is a schematic diagram illustrating an inspection tool according to the third embodiment of the invention. FIG. 12 is a block diagram illustrating the image pickup device and the circuits connected to the image pickup device. FIGS. 11 and 12 correspond to FIGS. 1 and 5, respectively. The members that are described above and illustrated in FIGS. 11 and 12 are indicated by the same reference numerals and symbols as those illustrated in FIGS. 1 to 5, 8 and 9, and a description thereof is omitted. The configuration of the image pickup device 32H is not illustrated in FIG. 12, but is the same as the configuration of the image pickup device 32L.

The third embodiment is different in the following point from the first embodiment. While the D-MUX 50 is not arranged in the image pickup device 32L in the first embodiment, the D-MUX 50 is arranged in the image pickup device 32 in the third embodiment. Specifically, the channels are integrated on the image pickup device 32L by the A-MUXs 34d and the D-MUX 50 using a hybrid scheme for analog and digital signals. In the present embodiment, together with the photoelectronic devices 33 and the signal processing function chips 34A, the D-MUX 50 is stored in the package 35 illustrated in FIGS. 2 to 4. The D-MUX 50 may be stored in the package 35 as a different chip from the photoelectronic devices 33 and the signal processing function chips 34A (as illustrated in the configuration example of FIG. 3) or formed on the same chip as the photoelectronic devices 33 and the signal processing function chips 34A and stored in the package 35 (as illustrated in the configuration example of FIG. 4).

Other configurations are the same as those described in the first embodiment. Operations of the image pickup device 32L are also the same as those described in the first embodiment. Operations of the image pickup device 32H are the same as the operations of the image pickup device 32L.

According to the present embodiment, in addition to the effect similar to that of the first embodiment, the number of output channels can be small and the circuit for processing signals to be output can be downsized by integrating the plurality of channels by the A-MUXs 34c and integrating outputs of the A-MUXs 34c on the image pickup devices 32L and 32H on the downstream side of the A-MUXs 34c.

The processing speeds of the A-MUXs 34c are lowest among the circuits formed on the image pickup devices 32L and 32H in general. On the other hand, the D-MUX 50 can be driven at a frequency in a GHz range. Thus, if a configuration in which the number of channels to be integrated by the A-MUXs 34c is reduced and the number of channels to be integrated by the D-MUX 50 is increased is used or a configuration in which the A-MUXs 34c are omitted and outputs of the S/Hs 34b are directly input to the D-MUX 50 through the ADCs 34d is used, the configuration has an advantage in processing speeds. If the A-MUXs 34c are omitted or the number of channels to be integrated by the A-MUXs 34c is reduced, however, the number of ADCs 34d cannot be reduced. Thus, if the A-MUXs 34c are not connected in an efficient manner, the effect of downsizing the circuit may be reduced as the number of pixels is increased. It is, therefore, desirable that the number of channels to be integrated by the A-MUXs 34c and the number of channels to be integrated by the D-MUX 50 be appropriately set in consideration of the number of pixels and the like.

### Others

Although the first to third embodiments describe that each of the A-MUXs 34c integrates four channels as an example, the number of channels integrated by each of the A-MUXs 34c is not limited to four. The configurations that each include the D-MUX 50 are described above as examples. However, if the numbers of the pixels of the image pickup devices 32L and 32H are small and the D-MUX 50 does not need to be arranged, the D-MUX 50 and the D-MUX controller 40e may be omitted. Although the first to third embodiments describe that the photoelectronic devices 33 are arranged in a row and formed in the line sensor shape, the photoelectronic devices 33 may be two-dimensionally arranged. The first to third embodiments describe that the present invention is applied to the inspection tool that moves the stage device 10 while rotating the wafer W for an inspection as an example. However, the invention can be applied to an inspection tool that moves a stage device in X and Y directions for an inspection and inspects a general wafer with a circuit pattern formed thereon. Specifically, the inspection tool has an XY table for moving a sample stage in a horizontal direction (X and Y directions) and a sample stage movement mechanism that has an autofocus mechanism (not illustrated) that moves the sample stage and the XY table in a vertical direction (Z direction) and automatically focuses inspection light L1 and L3. In addition, each of the first to third embodiments describes the inspection tool that includes the plurality of image pickup devices 32 as an example. The present invention can be applied to a general inspection tool that includes a single image pickup device.

1. An image pickup device that is used for an inspection tool, comprising:
a plurality of photoelectronic devices of a photoelectron output type;
a plurality of sample-and-hold circuits, each circuit being connected to corresponding one of the photoelectronic devices;
at least one analog multiplexer that is connected to the plurality of sample-and-hold circuits;
an analog-to-digital converting circuit that is connected to the corresponding analog multiplexer; and
a package that stores the photoelectronic devices, the sample-and-hold circuits, the analog multiplexer and the analog-to-digital converting circuit.

2. An image pickup device that is used for an inspection tool, comprising:
a plurality of photoelectronic devices of a photoelectron output type;
a plurality of sample-and-hold circuits, each circuit being connected to corresponding one of the photoelectronic devices;
a plurality of analog multiplexers that are connected to the plurality of sample-and-hold circuits;
a plurality of analog-to-digital converting circuits, each circuit being connected to corresponding one of the analog multiplexers;
at least one digital multiplexer that is connected to the plurality of analog-to-digital converting circuits; and
a package that stores the photoelectronic devices, the sample-and-hold circuits, the analog multiplexers, the analog-to-digital converting circuits and the digital multiplexer.

3. The image pickup device according to claim 1,
wherein the photoelectronic devices are photodiodes, avalanche photodiodes, or multi-pixel photon counters.

4. The image pickup device according to claim 1, further comprising
a plurality of current-to-voltage converting circuits that are arranged between the photoelectronic devices and the sample-and-hold circuits.

5. The image pickup device according to claim 1, further comprising
a plurality of storage capacitors that are arranged between the photoelectronic devices and the sample-and-hold circuits.

6. An inspection tool comprising:
a stage device that holds a wafer;
an illumination device that irradiates the wafer placed on the stage device with inspection light; and
an image pickup device that detects light scattered from the wafer,
wherein the image pickup device includes
a plurality of photoelectronic devices of a photoelectron output type;
a plurality of sample-and-hold circuits, each circuit being connected to corresponding one of the photoelectronic devices;
at least one analog multiplexer that is connected to the plurality of sample-and-hold circuits;
an analog-to-digital converting circuit that is connected to the corresponding analog multiplexer; and
a package that stores the photoelectronic devices, the sample-and-hold circuits, the analog multiplexer and the analog-to-digital converting circuit.

7. The inspection tool according to claim 6,
wherein the photoelectronic devices are photodiodes, avalanche photodiodes, or multi-pixel photon counters.

8. The inspection tool according to claim 6, further comprising
a plurality of current-to-voltage converting circuits that are arranged between the photoelectronic devices and the sample-and-hold circuits.

9. The inspection tool according to claim 8, further comprising:
an illumination device that uses pulse illumination;
a light detector that detects light emitted by the illumination device; and
a control signal generating unit that controls an operation of the image pickup device on the basis of a detection signal received from the light detector.

10. The inspection tool according to claim 9, wherein the control signal generating unit includes
a sample-and-hold controller that outputs, to the plurality of sample-and-hold circuits, a control signal that instructs the sample-and-hold circuits to sample optical currents of the photoelectronic devices and hold the optical currents for a sampling period upon the illumination of the illumination device,
an analog multiplexer controller that outputs, to the analog multiplexer, a control signal that instructs the analog multiplexer to sequentially receive and output signals held by the sample-and-hold circuits during the sampling period, and
an analog-to digital converting circuit controller that causes the analog-to-digital converting circuit to sequentially digitalize signals received from the analog multiplexer.

11. The inspection tool according to claim 6, further comprising
a plurality of storage capacitors that are arranged between the photoelectronic devices and the sample-and-hold circuits.

12. The inspection tool according to claim 11, further comprising:
an illumination device that uses continuous illumination;
a position detector that detects the position of the stage device; and
a control signal generating unit that controls an operation of the image pickup device on the basis of a detection signal received from the position detector.

13. The inspection tool according to claim 12, wherein the control signal generating unit includes
a storage capacitor controller that outputs, to the storage capacitors, a control signal that causes the storage capacitors to switch between an operation of accumulating an optical current and an operation of discharging an optical current,
a sample-and-hold controller that outputs, to the sample-and-hold circuits, a control signal that causes the sample-and-hold circuits to sample optical currents accumulated in the storage capacitors and hold the optical currents for a sampling period,
an analog multiplexer controller that outputs, to the analog multiplexer, a control signal that causes the analog multiplexer to sequentially receive and output signals held by the sample-and-hold circuits during the sampling period, and
an analog-to-digital converting circuit controller that causes the analog-to-digital converting circuit to sequentially digitalize signals received from the analog multiplexer.

14. The inspection tool according to claim 10,
wherein the image pickup device includes at least one digital multiplexer that is connected to a plurality of analog-to-digital converting circuits, and
wherein the control signal generating unit includes a digital multiplexer controller that outputs, to the digital multiplexer, a control signal that causes the digital multiplexer to sequentially receive and output signals output from the analog-to-digital converting circuits.

15. The inspection tool according to claim 10, further comprising:
an interface that receives a setting for inspection of the wafer; and
a control unit that calculates an operational control value for the image pickup device on the basis of a condition input to the interface and outputs the operational control value to the control signal generating unit.

16. The image pickup device according to claim 2,
wherein the photoelectronic devices are photodiodes, avalanche photodiodes, or multi-pixel photon counters.

17. The image pickup device according to claim 2, further comprising
a plurality of current-to-voltage converting circuits that are arranged between the photoelectronic devices and the sample-and-hold circuits.

18. The image pickup device according to claim 2, further comprising
a plurality of storage capacitors that are arranged between the photoelectronic devices and the sample-and-hold circuits.

19. The inspection tool according to claim 13,
wherein the image pickup device includes at least one digital multiplexer that is connected to a plurality of analog-to-digital converting circuits, and
wherein the control signal generating unit includes a digital multiplexer controller that outputs, to the digital multiplexer, a control signal that causes the digital multiplexer to sequentially receive and output signals output from the analog-to-digital converting circuits.

20. The inspection tool according to claim 13, further comprising:
an interface that receives a setting for inspection of the wafer; and
a control unit that calculates an operational control value for the image pickup device on the basis of a condition input to the interface and outputs the operational control value to the control signal generating unit.
